(19) United States
(12) Patent Application Publication
(10) Pub. No.: US 2006/0132479 A1
(43) Pub. Date: Jun. 22, 2006

(54) Image display device for generating input image signals in best mode and method thereof

(75) Inventor: Joo-sun Hong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/206,080

(22) Filed: Aug. 18, 2005

(30) Foreign Application Priority Data
Dec. 16, 2004 (KR) 2004-106846

(51) Int. Cl. G09G 5/00

(52) U.S. Cl. 345/213

(57) ABSTRACT

Disclosed is an image display device for generating input image signals and a method thereof. The image display device includes an outer device connector connected with a digital video interactive (DVI) cable or a high-definition multimedia interface (HDMI) cable, an image signal separator separating an image signal received through the cable into image data, vertical/horizontal synchronizing signals, a data enable (DE) signal, and a pixel clock signal, an image signal processor processing a signal of the image data, and a controller determining the standard of the input image signal and controlling the image signal processor to process the image signal in a mode corresponding to the determined standard. Thus, the input image signal can be processed depending on the determined result after determining the standard of the input image signal.

### CROSS-REFERENCE TO RELATED APPLICATIONS

This application claims benefit under 35 U.S.C. § 119 from Korean Patent Application No. 2004-106846, filed on Dec. 16, 2004, the entire content of which is incorporated herein by reference.

### BACKGROUND OF THE INVENTION

1. Field of the Invention

The present invention relates to an image display device for generating input image signals in a best mode and a method thereof, and more particularly to, an image display device for generating input image signals and a method thereof, in which the image signals according to each standard are generated in a best mode by distinguishing an image signal of a video electronics standards association (VESA) standard and an image signal of electronic industry association/consumer electronics association (EIA/CEA861B) standard, which are input to the image display device, from each other.

2. Description of the Related Art

Recently, with the increase in popularity of digital image display devices such as an LCD monitor, a digital video interactive (DVI) and a high-definition multimedia interface (HDMI) have received attention with regard to a digital interface between a PC and the image display device and between an HD set-top box and the image display device. Cables for DVI and HDMI are used to transmit the image signal from the PC and the HD set top box to the image display device. In this case, a VESA standard is used to transmit the image signal between the PC and the image display device while an EIA/CEA861B standard is used to transmit the image signal between the HD set-top box and the image display device.

As described above, since the VESA standard and the EIA/CEA861B standard are together used through the DVI cable and the HDMI cable, a problem may occur in images if the image signal corresponding to the VESA standard and the image signal corresponding to the ELA/CEA861B standard are processed in the same method. In more detail, in the case where the image signal corresponds to the VESA standard, a digital value of 0 to 255 is used for a luminance signal level. In the case where the image signal corresponds to the ELA/CEA861B standard, a digital value of 16 to 235 is used for the luminance signal level. If the image signal corresponding to the VESA standard is input to the image display device which employs the EIA/CEA861B standard, an abnormal phenomenon such as saturation of image occurs.

### SUMMARY OF THE INVENTION

Accordingly, the present invention is directed to an image display device for generating input image signals in a best mode and a method thereof, which substantially obviates one or more problems due to limitations and disadvantages of the related art.

An aspect of the present invention is to provide an image display device for generating input image signals in a best mode and a method thereof, in which the image signals inputted through a digital video interactive (DVI) or a high-definition multimedia interface (HDMI) are generated in a best mode by distinguishing an image signal of a Video Electronics Standards Association (VESA) standard and an image signal of an Electronic Industry Association/Consumer Electronics Association (EIA/CEA861B) standard, which are input to the image display device, from each other.

To achieve these aspects and other advantages and in accordance with the purpose of the invention, as embodied and broadly described herein, an image display device includes an outer device connector connected with a digital video interactive (DVI) cable or a high-definition multimedia interface (HDMI) cable, an image signal separator separating an image signal received through the cable into image data, vertical/horizontal synchronizing signals, a data enable (DE) signal, and a pixel clock signal, an image signal processor processing a signal of the image data, and a controller determining the standard of the input image signal and controlling the image signal processor to process the image signal in a mode corresponding to the determined standard.

The controller includes a first determining portion determining the standard of the image signal based on the vertical/horizontal synchronizing signals, the data enable signal, and the pixel clock signal, a second determining portion determining the standard of the image signal based on a signal level of data corresponding to a luminance signal among the image data, and a comparator comparing a first determined result of the first determining portion with a second determined result of the second determining portion.

The first determining portion includes a resolution determining portion determining resolution based on the vertical/horizontal synchronizing signals, and a standard determining portion determining either the standard of the input image signal based on the number of H-sync periods in a V-sync period of the input image signal if the resolution corresponds to 480p or the standard of the input image signal based on the number of pixel clocks in a H_Front porch period if the resolution corresponds to 720p or 1080i.

The comparator determines whether the first determined result is equal to the second determined result and controls the image signal processor to process the input image signal in a mode corresponding to the determined standard if the first determined result is equal to the second determined result.

The comparator transmits a reset signal to the outer device connector to initiate the input image signal and determines again the standard of the initiated input image signal if it determines that the first determined result is different from the second determined result.

According to the present invention, a method for outputting input image signals of an image display device, comprises receiving an input image signal through at least one cable of a digital video interactive (DVI) cable and a high-definition multimedia interface (HDMI) cable, separating the input image signal into image data, vertical/horizontal synchronizing signals, a data enable (DE) signal, and a pixel clock signal, determining the standard of the input image signal, and processing the input image signal according to the standard and outputting the input image signal.

The step of determining the standard of the input image signal, may comprise determining the standard of the input image signal based on the vertical/horizontal synchronizing signals, the data enable signal, and the pixel clock signal, and outputting a first determined result, determining the standard of the input image signal based on a signal level of data corresponding to a luminance signal among the image data, and outputting a second determined result, and comparing the first determined result with the second determined result.

The step of outputting the first determined result may comprise determining a resolution based on the vertical/horizontal synchronizing signals, and determining either the standard of the input image signal based on the number of H-sync periods in a V-sync period of the input image signal if the resolution corresponds to 480p or the standard of the input image signal based on the number of pixel clocks in a H_Front porch period if the resolution corresponds to 720p or 1080i.

The method may further comprise, if the first determined result is equal to the second determined result, processing the input image signal in a mode corresponding to the determined standard.

The method may further comprise, if it is determined that the first determined result is different from the second determined result, initiating the input image signal and determining again the standard of the initiated input image signal.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram illustrating an image display device according to an exemplary embodiment of the present invention;

FIG. 2A illustrates the difference between an image signal corresponding to a VESA standard and an image signal corresponding to an EIA/CEA861B standard in a mode of 480p;

FIG. 2B illustrates the difference between an image signal corresponding to a VESA standard and an image signal corresponding to an EIA/CEA861B standard in a mode of 720p;

FIG. 2C illustrates the difference between an image signal corresponding to a VESA standard and an image signal corresponding to an EIA/CEA861B standard in a mode of 1080i; and

FIG. 3 is a flow chart illustrating the operation of an image display device according to an exemplary embodiment of the present invention.

### DETAILED DESCRIPTION OF EXEMPLARY EMBODIMENTS

Reference will now be made in detail to exemplary embodiments of the present invention, some of which are illustrated in the accompanying drawings. Wherever possible, the same reference numbers will be used throughout the drawings to refer to the same or like parts.

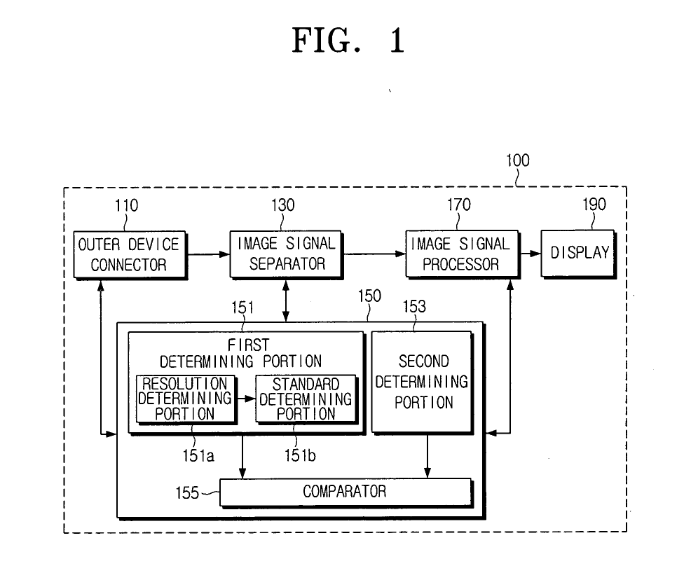

FIG. 1 is a block diagram illustrating an image display device according to an exemplary embodiment of the present invention.

Referring to FIG. 1, an image display device consistent with the present invention includes an outer device connector 110, an image signal separator 130, a controller 150, an image signal processor 170, and a display 190.

The outer device connector 110 is connected with an outer device (not shown), such as a PC and an HD set-top box, through a DVI cable and an HDMI cable.

The image signal separator 130 separates an image signal transmitted from the outer device into image data of 24-bit, vertical/horizontal synchronizing signals, a data enable (DE) signal, and a pixel clock signal. The image signal separator 130 transmits the separated values to a controller 150 as described later.

After receiving the image data of 24-bit, the vertical/horizontal synchronizing signals, the data enable (DE) signal, and the pixel clock signal from the image signal separator 130, the controller 150 determines the standard of the input image signals. The controller 150 includes a first determining portion 151, a second determining portion 153, and a comparator 155.

The first determining portion 151 receives the vertical/horizontal synchronizing signals, the data enable (DE) signal, and the pixel clock signal to determine the standard of the input image signals. In other words, a resolution determining portion 151a determines whether resolution of the input image signals is 480p, 720p, or 1080i based on the vertical/horizontal synchronizing signals. A standard determining portion 151b determines whether the input image signals corresponds to either a VESA standard or an EIA/CEA861B standard based on the vertical/horizontal synchronizing signals, the data enable signal, and the pixel clock signal.

The image signal corresponding to the VESA standard and the image signal corresponding to the EIA/CEA861B standard have differences depending on resolution as shown in the following Table 1.

TABLE 1

| | | H_{—} | | H_{—} | V_{—} | | V_{—} | |
|---|---|---|---|---|---|---|---|---|
| | Reso- | Front | H_{—} | Back | Front | V_{—} | Back | Po- |
| | lution | porch | sync | porch | porch | sync | porch | larity |
| VESA | 480p | 16T | 62T | 60T | 10H | 2H | 33H | N/N |
| | 720p | 70T | 40T | 260T | 5H | 5H | 20H | N/N |
| | 1080i | 44T | 44T | 192T | 2H | 5H | 15H | N/N |
| EIA/CE | 480p | 16T | 62T | 60T | 9H | 6H | 30H | N/N |
| A 861B | 720p | 110T | 40T | 220T | 5H | 5H | 20H | P/P |
| | 1080i | 88T | 44T | 148T | 2H | 5H | 15H | P/P |

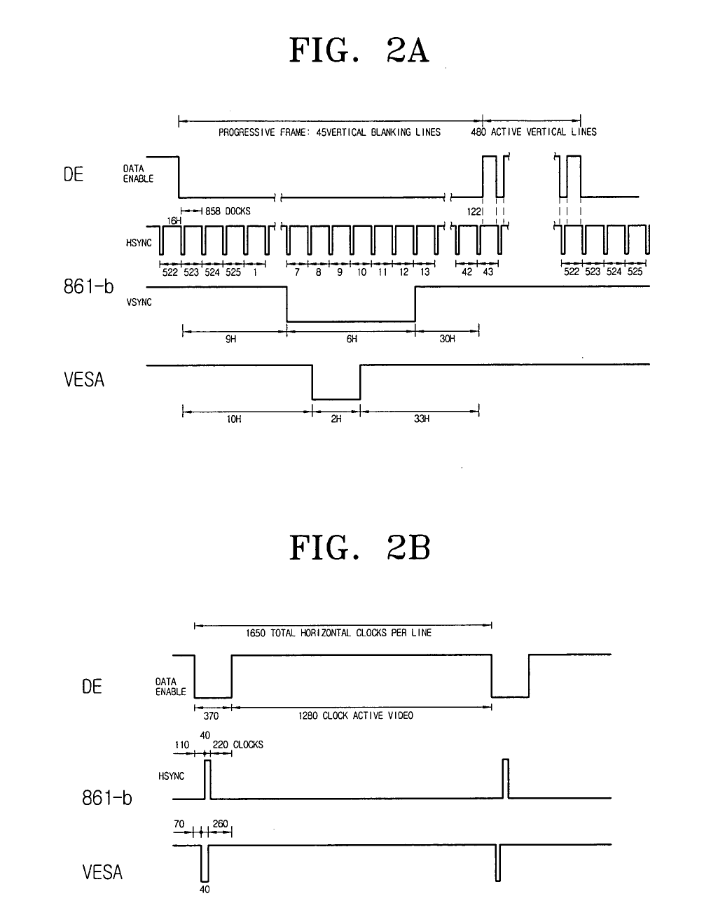

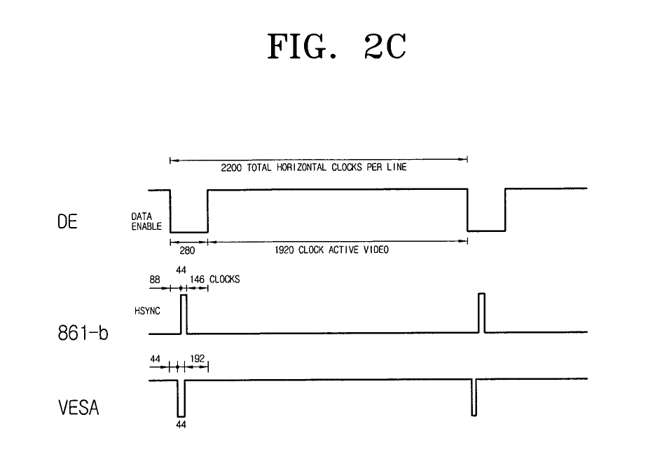

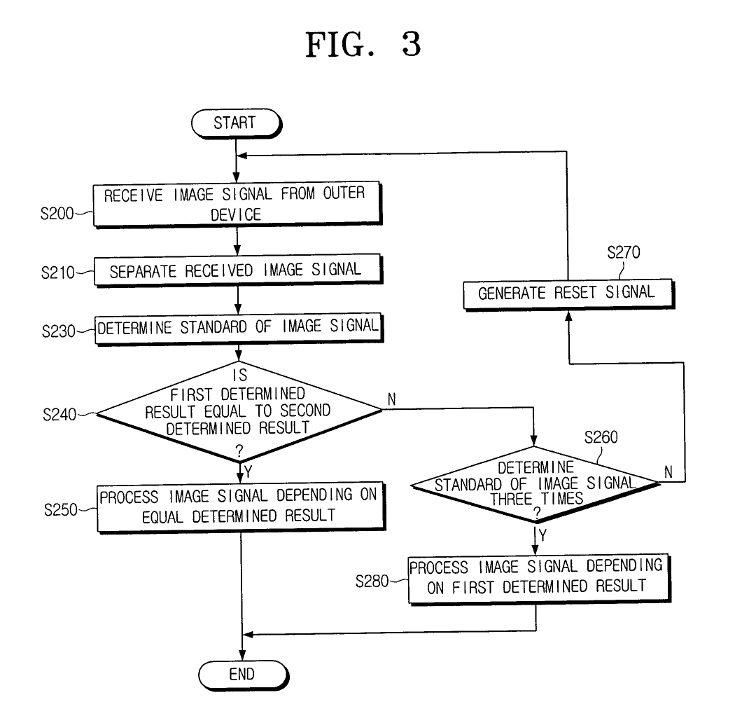

In Table 1, T represents the number of pixel clocks, and H represents the number of H_sync periods. The standard determining portion 151b determines the standard of the input image signals based on the difference between the image signal corresponding to the VESA standard and the image signal corresponding to the EIA/CEA861B standard. The difference between the image signal corresponding to the VESA standard and the image signal corresponding to the EIA/CEA861B standard as shown in Table 1 will be described with reference to FIG. 2A to FIG. 2C.

The second determining portion 153 receives the image data of 24-bit, compares signal levels of 8-bit data corresponding to a luminance signal among the image data of 24-bit, and determines whether the input image signals correspond to the VESA standard or the ELA/CEA861B standard.

In other words, a luminance signal corresponding to the VESA standard has a signal level of 0 to 255 while the image signal corresponding to the EIA/CEA861B standard has a signal level of 16 to 235. Therefore, if the luminance signal input during 30 frames has the signal levels of 1 to 8 and 245 to 255, the second determining portion 153 determines the signal level as the VESA standard. If not, the second determining portion 153 determines the signal level as the EIA/CEA861B standard.

The comparator 155 compares the result of the first determining portion 151 with the result of the second determining portion 153. If the result of the first determining portion 151 is equal to the result of the second determining portion 153, the comparator 155 controls the image signal processor 170, which will be described later, to process the image signal corresponding to the VESA standard or the EIA/CEA861B standard.

If the result of the first determining portion 151 is different from the result of the second determining portion 153, the comparator 155 transmits a reset signal to the outer device connector 110 to initiate the image signal input from the outer device. The image signal separator 130 receives again the image signal and separates the received image signal. The first determining portion 151 and the second determining portion 153 determine the standard of the image signal again. The comparator 155 compares the result of the first determining portion 151 with the result of the second determining portion 153. If the result of the first determining portion 151 is equal to the result of the second determining portion 153, the comparator 155 controls the image signal processor 170 to process the image signal depending on the determined result. If the result of the first determining portion 151 is different from the result of the second determining portion 153, the comparator 155 transmits the reset signal to the outer device connector 110. In this way, if the above two results are different from each other, the controller 150 performs the determining procedures three times. If the result of the first determining portion 151 is different from the result of the second determining portion 153 even after performing the determining procedures three times, the controller 150 controls the image signal processor 170 to process the image signal depending on the standard determined by the first determining portion 151.

The image signal processor 170 receives the image data of 24-bit from the image signal separator 130 and processes the image signal of the received data. At this time, the image signal processor 170 processes the image signal depending on the standard determined by the controller 150.

The display 190 outputs the image signal processed by the image signal processor 170 to the screen to allow a user to view it.

FIG. 2A illustrates the difference between the image signal corresponding to the VESA standard and the image signal corresponding to the EIA/CEA861B in a mode of 480p.

Referring to FIG. 2A, if the resolution determining portion 151a determines the input image signal as the mode of 480p, the standard determining portion 151b determines the standard based on the number of H_sync periods in a V_sync period of the input image signal. In other words, if the input image signal corresponds to the VESA standard, the number of H_sync periods in the V_sync period is 2H. If the input image signal corresponds to the EIA/CEA861B standard, the number of H_sync periods in the V_sync period is 6H. The standard determining portion 151b determines the input image signal as the VESA standard if the number of H_Sync periods in the V_sync period is 2H to 3H. On the other hand, the standard determining portion 151b determines the input image signal as the EIA/CEA861B standard if the number of H_sync periods in the V_sync period is 5H to 7H.

FIG. 2B illustrates the difference between the image signal corresponding to the VESA standard and the image signal corresponding to the EIA/CEA861B in a mode of 720p.

Referring to FIG. 2B, if the resolution determining portion 151a determines the input image signal as the mode of 720p, the standard determining portion 151b determines the standard based on the number of pixel clocks in a H_Front porch period. In other words, if the input image signal corresponds to the VESA standard, the number of pixel clocks in the H_Front porch period is 70T. If the input image signal corresponds to the EIA/CEA861B standard, the number of pixel clocks in the H_Front porch period is 110T. The standard determining portion 151b determines the input image signal as the VESA standard if the number of pixel clocks in the H_Front porch period is 60T to 80T. On the other hand, the standard determining portion 151b determines the input image signal as the EIA/CEA861B standard if the number of pixel clocks in the H_Front porch period is 100T to 120T.

FIG. 2C illustrates the difference between the image signal corresponding to the VESA standard and the image signal corresponding to the EIA/CEA861B in a mode of 1080i.

Referring to FIG. 2C, if the resolution determining portion 151a determines the input image signal as the mode of 1080i, the standard determining portion 151b determines the standard based on the number of pixel clocks in a H_Front porch period. In other words, if the input image signal corresponds to the VESA standard, the number of pixel clocks in the H_Front porch period is 44T. If the input image signal corresponds to the ELA/CEA861B standard, the number of pixel clocks in the H_Front porch period is 88T. The standard determining portion 151b determines the input image signal as the VESA standard if the number of pixel clocks in the H_Front porch period is 40T to 50T. On the other hand, the standard determining portion 151b determines the input image signal as the EIA/CEA861B standard if the number of pixel clocks in the H_Front porch period is 80T to 100T.

FIG. 3 is a flow chart illustrating the operation of an image display device according to an exemplary embodiment of the present invention.

Referring to FIG. 3, the outer device connector receives the image signal from the outer device connected with the outer device connector 110 through the DVI cable or the HDMI cable (S200).

The image signal separator 130 separates the input image signal into the image data of 24-bit, the vertical/horizontal synchronizing signals, the data enable signal, and the pixel clock signal (S210).

After determining resolution of the input image signal based on the vertical/horizontal synchronizing signals, the first determining portion 151 determines the standard of the input image signal based on the vertical/horizontal synchronizing signals, the data enable signal, and the pixel clock signal. The second determining portion 153 receives the image data of 24-bit and compares signal levels of 8-bit data corresponding to a luminance signal among the image data of 24-bit to determine the standard of the input image signal (S230).

The comparator 155 compares the first determined result of the first determining portion 151 with the second determined result of the second determining portion 153 to determine whether the results are equal to each other (S240).

As a result, if the first determined result is equal to the second determined result, the comparator 155 processes the image signal depending on the result to output the processed image signal to the screen (S250).

If the first determined result is different from the second determined result, the reset signal is generated to initiate the image signal received from the outer device (S270). Then, the steps S200 to S240 are repeated three times. If the first determined result is different from the second determined result in spite of the repeated steps of three times (S260), the comparator 155 processes the image signal depending on the first determined result to output the processed image signal to the screen (S280). The standard of the input image signal can be determined by the above steps.

As described above, brightness and picture quality of the screen can be realized in the best mode by determining the standard of the image signal input through the DVI cable or the HDMI cable. The image display device becomes compatible with its peripheral devices connected thereto through the DVI cable or the HDMI cable.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An image display device comprising:
an outer device connector connected with a digital video interactive (DVI) cable or a high-definition multimedia interface (HDMI) cable;
an image signal separator separating an image signal received through the cable into image data, vertical/horizontal synchronizing signals, a data enable (DE) signal, and a pixel clock signal;
an image signal processor processing a signal of the image data; and
a controller determining the standard of the input image signal and controlling the image signal processor to process the image signal in a mode corresponding to the determined standard.

2. The image display device according to claim 1, wherein the controller includes:
a first determining portion determining the standard of the image signal based on the vertical/horizontal synchronizing signals, the data enable signal, and the pixel clock signal;
a second determining portion determining the standard of the image signal based on a signal level of data corresponding to a luminance signal among the image data; and
a comparator comparing a first determined result of the first determining portion with a second determined result of the second determining portion.

3. The image display device according to claim 2, wherein the first determining portion includes:
a resolution determining portion determining resolution based on the vertical/horizontal synchronizing signals; and
a standard determining portion determining either the standard of the input image signal based on the number of H-sync periods in a V-sync period of the input image signal if the resolution corresponds to 480p or the standard of the input image signal based on the number of pixel clocks in a H_Front porch period if the resolution corresponds to 720p or 1080i.

4. The image display device according to claim 2, wherein the comparator determines whether the first determined result is equal to the second determined result and controls the image signal processor to process the input image signal in a mode corresponding to the determined standard if the first determined result is equal to the second determined result.

5. The image display device according to claim 2, wherein the comparator transmits a reset signal to the outer device connector to initiate the input image signal and determines again the standard of the initiated input image signal if the comparator determines that the first determined result is different from the second determined result.

6. A method for outputting input image signals of an image display device, comprising:
receiving an input image signal through at least one cable of a digital video interactive (DVI) cable and a high-definition multimedia interface (HDMI) cable;
separating the input image signal into image data, vertical/horizontal synchronizing signals, a data enable (DE) signal, and a pixel clock signal;
determining the standard of the input image signal; and
processing the input image signal according to the standard and outputting the input image signal.

7. The method according to claim 6, wherein the step of determining the standard of the input image signal, comprises:
determining the standard of the input image signal based on the vertical/horizontal synchronizing signals, the data enable signal, and the pixel clock signal, and outputting a first determined result;
determining the standard of the input image signal based on a signal level of data corresponding to a luminance signal among the image data, and outputting a second determined result; and
comparing the first determined result with the second determined result.

8. The method according to claim 7, wherein the step of outputting the first determined result comprises:
determining a resolution based on the vertical/horizontal synchronizing signals; and
determining either the standard of the input image signal based on the number of H-sync periods in a V-sync period of the input image signal if the resolution corresponds to 480p or the standard of the input image signal based on the number of pixel clocks in a H_Front porch period if the resolution corresponds to 720p or 1080i.

9. The method according to claim 7, further comprising, if the first determined result is equal to the second determined result, processing the input image signal in a mode corresponding to the determined standard.

10. The method according to claim 7, further comprising, if it is determined that the first determined result is different from the second determined result, initiating the input image signal and determining again the standard of the initiated input image signal.
